(19) United States
(12) Patent Application Publication
(10) Pub. No.: US 2006/0179587 A1
(43) Pub. Date: Aug. 17, 2006

(54) Dyeing composition comprising a specific pigment and at least one electrophilic monomer

(76) Inventor: Gaelle Brun, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/249,132

(22) Filed: Oct. 13, 2005

(30) Foreign Application Priority Data
Oct. 13, 2004 (FR) 04 10801

(51) Int. Cl. C09K 3/00

(52) U.S. Cl. 8/536; 106/34

(57) ABSTRACT

The invention relates to a dyeing composition comprising, in an appropriate dyeing medium, at least one electrophilic monomer and at least one pigment comprising at least one organic part. The composition in accordance with the invention makes it possible to obtain a visible and very chromatic coloration on a dark keratin material. In particular, in the case of dark keratin fibres, a very visible chromatic coloration is obtained without it being necessary to lighten or bleach the keratin fibres and, consequently, without physical degradation of the keratin fibres.

The present invention relates to a composition for dyeing keratin materials, in particular keratin fibres such as the hair, comprising at least one specific pigment and at least one electrophilic monomer.

In the field of the dyeing of keratin fibres, it is already known practice to dye keratin fibres by various techniques using direct dyes or pigments for temporary colorations or using dye precursors for permanent colorations.

Temporary coloration or direct coloration consist in dyeing the keratin fibres with dye compositions containing direct dyes. These dyes are coloured and colouring molecules that have an affinity for keratin fibres. They are applied to the keratin fibres for a period of time necessary to obtain the desired coloration, and then rinsed off.

The conventional dyes that are used are in particular dyes of the nitrobenzene, anthraquinone, nitropyridine, azo, xanthene, acridine, azine or triarylmethane type or natural dyes.

Some of these dyes can be used under lightening conditions, which makes it possible to obtain visible colorations on dark hair.

It is also known practice to dye keratin fibres permanently by oxidation dyeing. This dyeing technique consists in applying to the keratin fibres a composition containing dye precursors such as oxidation bases and couplers. These precursors, under the action of an oxidizing agent, will form one or more coloured species in the hair.

The variety of molecules involved in oxidation bases and couplers makes it possible to obtain a rich array of colours and the colorations that result therefrom are permanent, strong, and resistant to outside agents, in particular to light, to bad weather, to washing, to perspiration and to rubbing.

In order to be visible on dark hair, these two dyeing techniques require prior or simultaneous bleaching of the keratin fibres. This bleaching step, carried out with an oxidizing agent such as hydrogen peroxide or persalts, results in a not insignificant degradation of the keratin fibres, which impairs their cosmetic properties. The hair then has a tendency to become coarse, more difficult to disentangle and more brittle.

Another method of dyeing consists in using pigments. In fact, the use of a pigment at the surface of keratin fibres makes it possible in general to obtain visible colorations on dark hair since the surface pigment masks the natural colour of the fibre. The use of a pigment for dyeing keratin fibres is, for example, described in patent application FR 2 741 530, which recommends the use, for dyeing keratin fibres, of a composition comprising at least one dispersion of particles of a film-forming polymer containing at least one acid function and at least one pigment dispersed in the continuous phase of said dispersion.

The colorations obtained by this method of dyeing have the drawback of having low shampoo fastness.

Moreover, compositions for treating the hair using compositions comprising electrophilic monomers are known from patent application FR 2 833 489. Such a composition makes it possible to obtain hair that is completely coated and not greasy.

The aim of the present invention is to provide novel compositions for dyeing keratin materials, and in particular keratin fibres such as the hair, which make it possible to obtain colorations that are visible on dark hair and very chromatic without it being necessary to lighten or bleach the fibres, and which exhibit good shampoo fastness.

This aim is achieved with the present invention, the subject of which is a dyeing composition comprising, in an appropriate dyeing medium, at least one electrophilic monomer and at least one pigment comprising at least one organic part.

The composition in accordance with the present invention makes it possible to obtain a visible and very chromatic coloration on a dark keratin material. In particular, in the case of dark keratin fibres, a very visible chromatic coloration is obtained without it being necessary to lighten or bleach the keratin fibres and, consequently, without physical degradation of the keratin fibres.

In addition, this coloration exhibits good resistance to the various attacking factors that the hair may be subjected to, such as shampoos, rubbing, light, bad weather, sweat and permanent reshaping operations. These properties are particularly notable with regard to the resistance of the coloration with respect to shampoos.

Given the variety of pigments that can be used in the composition of the invention, it is possible to obtain colorations in varied, strong and aesthetic shades and that may be chromatic.

A subject of the present invention is also a process for dyeing keratin materials which comprises the application of the composition of the invention to the keratin materials, and also the use of the composition of the invention for dyeing keratin materials, in particular keratin fibres such as the hair.

Another subject of the invention concerns a kit comprising a pigment comprising an organic part and an electrophilic monomer.

In the context of the invention, the pigment comprising at least one organic part exhibits a water-solubility of less than 0.01% at 20° C., preferably less than 0.0001%, and exhibits an absorption between 350 and 700 nm, preferably an absorption at a maximum.

The pigments that are useful in the present invention may be in the form of a pigmentary paste or powder.

In the context of the invention, the pigment comprising at least one organic part is a pigment that may be completely organic or that may comprise an organic part and another part such as a mineral part.

According to one embodiment, the pigment comprising at least one organic part is an organic pigment. The term “organic pigment” is intended to mean any pigment that corresponds to the definition in Ullmann's encyclopaedia in the organic pigment chapter. The organic pigment may in particular be chosen from nitroso, nitro, azo, xanthene, quinoline, anthraquinone and phthalocyanin compounds, compounds of metal complex type, and isoindolinone, isoindoline, quinacridone, perinone, perylene, diketopyrrolopyrrole, thioindigo, dioxazine, triphenylmethane and quinophthalone compounds.

The organic pigment(s) may be chosen, for example, from carmine, carbon black, aniline black, azo yellow, quinacridone, phthalocyanin blue, sorghum red, the blue pigments codified in the Color Index under the references CI 42090, 69800, 69825, 73000, 74100, 74160, the yellow pigments codified in the Color Index under the references CI 11680, 11710, 15985, 19140, 20040, 21100, 21108, 47000, 47005, the green pigments codified in the Color Index under the references CI 61565, 61570, 74260, the orange pigments codified in the Color Index under the references CI 11725, 15510, 45370, 71105, the red pigments codified in the Color Index under the references CI 12085, CI 12120, 12370, 12420, 12490, 14700, 15525, 15580, 15620, 15630, 15800, 15850, 15865, 15880, 17200, 26100, 45380, 45410, 58000, 73360, 73915, 75470, and the pigments obtained by oxidative polymerization of indole or phenolic derivatives as described in patent FR 2 679 771.

The pigment comprising at least one organic part may also be a pigmentary paste of organic pigment such as the products sold by the company Hoechst under the name:
JAUNE COSMENYL IOG: Pigment YELLOW 3 (CI 11710)
JAUNE COSMENYL G: Pigment YELLOW 1 (CI 11680)
ORANGE COSMENYL GR: Pigment ORANGE 43 (CI 71105)
ROUGE COSMENYL R″: Pigment RED 4 (CI 12085)
CARMIN COSMENYL FB: Pigment RED 5 (CI 12490)
VIOLET COSMENYL RL: Pigment VIOLET 23 (CI 51319)
BLEU COSMENYL A2R: Pigment BLUE 15.1 (CI 74160)
VERT COSMENYL GG: Pigment GREEN 7 (CI 74260)
NOIR COSMENYL R Pigment BLACK 7 (CI 77266)

The pigment comprising at least one organic part may also be in the form of composite pigments as described in patent EP 1 184 426. This composite pigment may be composed in particular of particles containing an inorganic core, at least one binder providing attachment of the organic pigments to the core, and at least one organic pigment that at least partially covers the core. Such pigments are, for example, described in patent application EP 1 184 426.

The pigment comprising at least one organic part may also be a lake consisting of inorganic substrates onto which organic pigments are adsorbed. The inorganic substrates are, for example: alumina, silica, calcium sodium borosilicate or calcium aluminium borosilicate, and aluminium. Among the organic dyes, mention may be made of cochineal carmine.

By way of examples of lakes, mention may be made of the products known under the names: D & C Red 21 (CI 45 380), D & C Orange 5 (CI 45 370), D & C Red 27 (CI 45 410), D & C Orange 10 (CI 45 425), D & C Red 3 (CI 45 430), D & C Red 7 (CI 15 850:1), D & C Red 4 (CI 15 510), D & C Red 33 (CI 17 200), D & C Yellow 5 (CI 19 140), D & C Yellow 6 (CI 15 985), D & C Green (CI 61 570), D & C Yellow 10 (CI 77 002), D & C Green 3 (CI 42 053), D & C Blue 1 (CI 42 090).

As a pigment comprising at least one organic part, mention may also be made of pearlescent pigments of the type mica coated with titanium, coated with an organic pigment of the abovementioned type.

According to a particular embodiment, the pigments are coloured pigments. The term “coloured pigment” is intended to mean pigments other than white pigments.

The size of the pigment that is useful in the context of the present invention is generally between 10 nm and 200 μm, preferably between 20 nm and 80 μm, and more preferably between 30 nm and 50 μm.

The pigment(s) comprising an organic part are each generally present in the composition in accordance with the invention in amounts generally of between 0.05 and 50% of the total weight of the composition, preferably from 0.1 to 35%.

Monomers

The electrophilic monomer(s) present in the composition of the invention may be chosen from
the benzylidenemalononitrile derivatives (A), 2-(4-chlorobenzylidene)malononitrile (A1), ethyl 2-cyano-3-phenylacrylate (B), ethyl 2-cyano-3-(4-chlorophenyl)acrylate (B1) described in Sayyah, J. Polymer Research, 2000, p 97

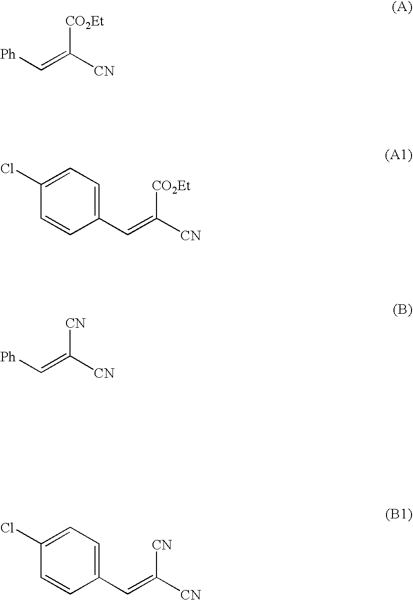

Methylidenemalonate derivates such as:
The diethyl 2-methylenemalonate (C) by Hopff, Makromoleculare Chemie, 1961, p 95, De Keyser, J. Pharm. Sci, 1991, p 67, and Klemarczyk, Polymer, 1998, p 173 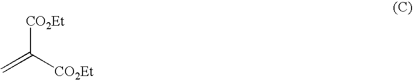
the ethyl 2-ethoxycarbonylmethyleneoxycarbonyl-acrylate (D) by Breton, Biomaterials, 1998, p 271 and Couvreur, Pharmaceutical Research, 1994, p 1270.

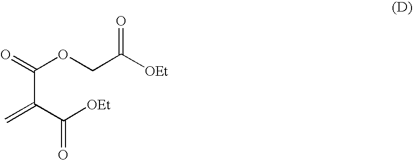

Itaconate and itaconimide derivatives such as:
the dimethyl itaconate (E) by Bachrach, European Polymer Journal, 1976, p 563 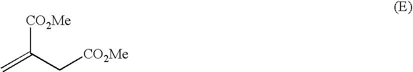
N-butylitaconimide (F), N-(4-tolyl)itaconimide (G), N-(2-ethylphenyl)itaconimide (H), N-(2,6-diethylphenyl)itaconimide (I) by Wanatabe, J. Polymer Science: Part A: Polymer chemistry, 1994, p 2073

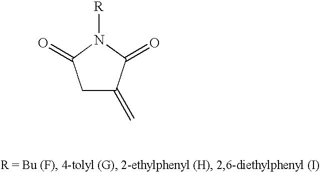

The methyl α-(methylsulphonyl)acrylate (K), ethyl α-(methylsulphonyl)acrylate (L), methyl α-(tert-butylsulphonyl)acrylate (M), tert-butyl α-(methylsulphonyl)acrylate (N) and tert-butyl α-(tert-butylsulphonyl)acrylate (O) derivatives by Gipstein, J. Org. Chem. 1980, p 1486 and the 1,1-bis(methylsulphonyl)ethylene (P), 1-acetyl-1-methylsulphonylethylene (Q), methyl α-(methyl-sulphonyl)vinylsulphonate (R), and α-methylsulphonyl-acrylonitrile (S) derivatives by Shearer, U.S. Pat. No. 2,748,050.

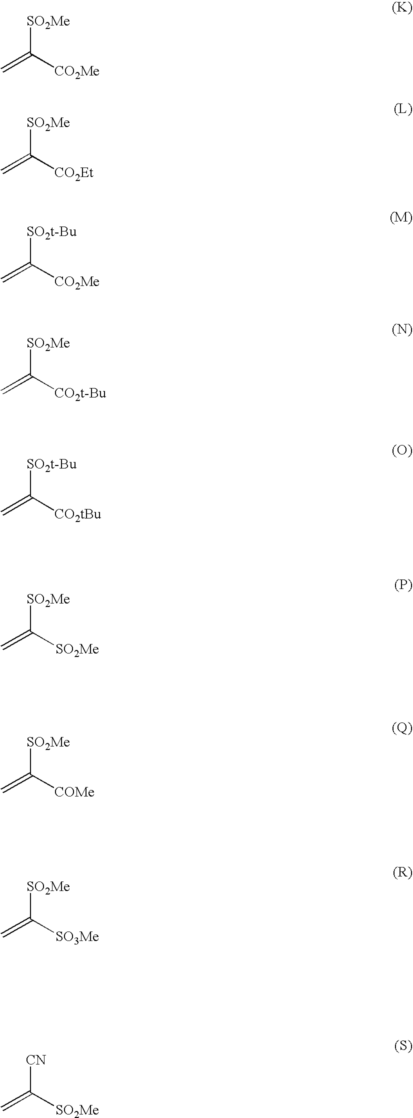

The methyl vinyl sulphone (T) and phenyl vinyl sulphone (U) derivatives by Boor, J. Polymer Science, 1971, p 249

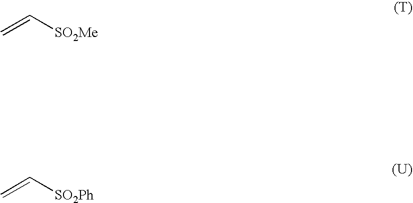

The phenyl vinyl sulphoxide derivative (V) by Kanga, Polymer preprints (ACS, Division of Polymer Chemistry), 1987, p 322

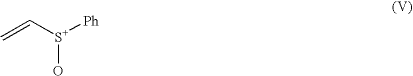

The 3-methyl-N-(phenylsulphonyl)-1-aza-1,3-butadiene derivative (W) by Bonner, Polymer Bulletin, 1992, p 517

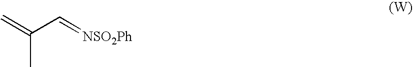

Acrylate and acrylamide derivatives such as:
N-propyl-N-(3-triisopropoxysilylpropyl)acrylamide (X) and N-propyl-N-(3-triethoxysilylpropyl)-acrylamide (Y) by Kobayashi, Journal of Polymer Science, Part A: Polymer Chemistry, 2005, p 2754. 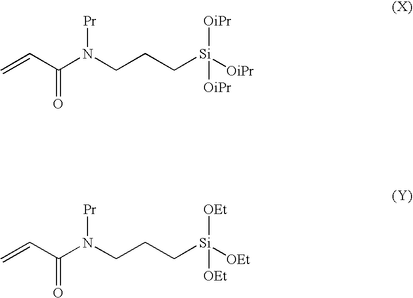
2-hydroxyethyl acrylate (Z) and 2-hydroxyethyl methacrylate (AA) by Rozenberg, International Journal of Plastics Technology, 2003, p 17 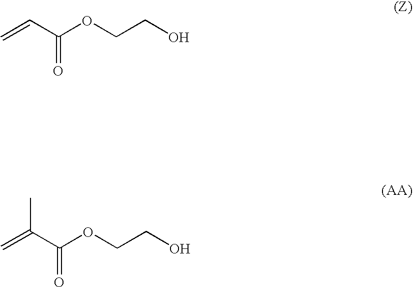
N-butyl acrylate (AB) by Schmitt, Macromolecules, 2001, p 2115
tert-butyl acrylate (AC) by Ishizone, Macromolecules, 1999, p 955.

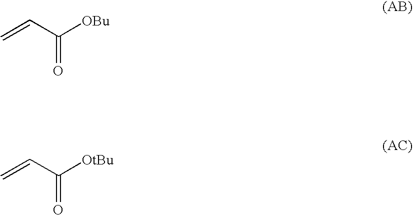

The electron-withdrawing monomer that is useful in the present invention may be cyclic or linear. When it is cyclic, the electron-withdrawing group is preferably exocyclic, i.e. it is not an integral part of the cyclic structure of the monomer.

According to a particular embodiment, these monomers have at least two electron-withdrawing groups.

By way of example of monomers having at least two electron-withdrawing groups, mention may be made of the monomers of formula (A): 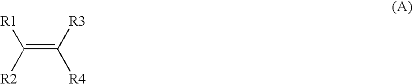
in which:
R₁ and R₂ each denote, independently of one another, a group with little or no electron-withdrawing effect (with little or no inductive withdrawing effect) such as:
   a hydrogen atom,
   a saturated or unsaturated, linear, branched or cyclic hydrocarbon-based group preferably containing from 1 to 20, even better still from 1 to 10, carbon atoms, and optionally containing one or more nitrogen, oxygen or sulphur atoms, and optionally substituted with one or more groups chosen from —OR, —COOR, —COR, —SH, —SR, —OH, and halogen atoms,
   a modified or unmodified polyorganosiloxane residue,
   a polyoxyalkylene group,
R₃ and R₄ each denote, independently of one another, an electron-withdrawing group (or group with inductive withdrawing effect) preferably chosen from the groups —N(R)3+, —S(R)2+, —SH2+, —NH3+, —NO₂, —SO₂R, —C≡N, —COOH, —COOR, —COSR, —CONH₂, —CONHR, —F, —Cl, —Br, —I, —OR, —COR, —SH, —SR and —OH, linear or branched alkenyl groups, linear or branched alkynyl groups, mono- or polyfluoro(C₁-C₄)alkyl groups, aryl groups such as phenyl, or aryloxy groups such as phenoxy,
R denotes a saturated or unsaturated, linear, branched or cyclic hydrocarbon-based group preferably containing from 1 to 20, even better still from 1 to 10, carbon atoms, and optionally containing one or more nitrogen, oxygen or sulphur atoms, and optionally substituted with one or more groups chosen from —OR′, —COOR′, —COR′, —SH, —SR′, —OH, halogen atoms, or a residue of a polymer that can be obtained by radical polymerization, by polycondensation or by ring opening, R′ denoting a C₁-C₁₀ alkyl group.

The term “electron-withdrawing group or group with inductive withdrawing effect (−1)” is intended to mean any group that is more electronegative than carbon. Reference may be made to the work P R Wells Prog. Phys. Org. Chem., Vol. 6, 111 (1968).

The expression “group with little or no electron-withdrawing effect” is intended to mean any group whose electronegativity is less than or equal to that of carbon.

The alkenyl or alkynyl groups preferably have 2 to 20 carbon atoms, even better still from 2 to 10 carbon atoms.

As a saturated or unsaturated, linear, branched or cyclic hydrocarbon-based group preferably containing from 1 to 20 carbon atoms, mention may in particular be made of linear or branched alkyl, alkenyl or alkynyl groups, such as methyl, ethyl, n-butyl, tert-butyl, isobutyl, pentyl, hexyl, octyl, butenyl or butynyl; cycloalkyl groups or aromatic groups.

As a substituted hydrocarbon-based group, mention may, for example, be made of hydroxyalkyl or polyhaloalkyl groups.

By way of examples of unmodified polyorganosiloxane, mention may in particular be made of polyalkylsiloxanes such as polydimethylsiloxanes, polyarylsiloxanes such as polyphenylsiloxanes, and polyarylalkylsiloxanes such as polymethylphenylsiloxanes.

Among modified polyorganosiloxanes, mention may in particular be made of polydimethylsiloxanes comprising polyoxyalkylene and/or siloxy and/or silanol and/or amine and/or imine and/or fluoroalkyl groups.

Among polyoxyalkylene groups, mention may in particular be made of polyoxyethylene groups and polyoxypropylene groups having preferably 1 to 200 oxyalkylenated units.

Among mono- or polyfluoroalkyl groups, mention may in particular be made of groups such as —(CH₂)n-(CF₂)m-CF₃ or —(CH₂)n-(CF₂)m-CHF₂ with n=1 to 20 and m=1 to 20.

The substituents R₁ to R₄ may optionally be substituted with a group having a cosmetic activity. The cosmetic activities particularly used are obtained from groups with colouring, antioxidant, UV-screening and conditioning functions.

By way of examples of a group with a colouring function, mention may in particular be made of azo, quinone, methine, cyanomethine and triaryl-methane groups.

By way of examples of a group with an antioxidant function, mention may in particular be made of groups of butylhydroxyanisole (BHA), butylhydroxy-toluene (BHT) or vitamin E type.

By way of examples of a group with a UV-screening function, mention may in particular be made of groups of benzophenone, cinnamate, benzoate, benzylidenecamphor and dibenzoylmethane types.

By way of examples of a group with a conditioning function, mention may in particular be made of cationic and fatty ester-type groups.

Among the monomers mentioned above, preference is given to monomers of the cyanoacrylate family and derivatives thereof of formula (B):

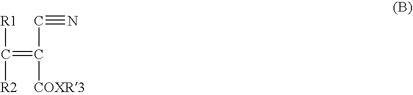

X denoting NH, S or O,

R1 and R2 having the same meanings as above, preferably R1 and R2 representing a hydrogen atom,

R′3 representing a hydrogen atom or R as defined in formula (A).

Preferably, X denotes O.

As compounds of formula (B), mention may be made of the monomers:
a) belonging to the family of polyfluoroalkyl 2-cyanoacrylates, such as:
2-cyano-2-propenoic acid 2,2,3,3-tetrafluoropropyl ester of formula: 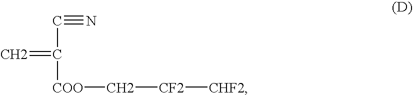
   or else 2-cyano-2-propenoic acid 2,2,2-trifluoroethyl ester of formula: 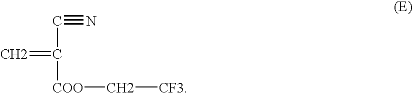
   b) alkyl or alkoxyalkyl 2-cyanoacrylates 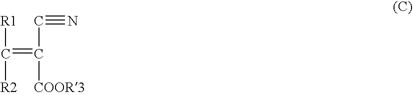
   in which R′3 represents a C₁-C₁₀ alkyl or (C₁-C₄)alkoxy(C₁-C₁₀)alkyl radical.

Mention may more particularly be made of ethyl 2-cyanoacrylate, methyl 2-cyanoacrylate, n-propyl 2-cyanoacrylate, isopropyl 2-cyanoacrylate, tert-butyl 2-cyanoacrylate, n-butyl 2-cyanoacrylate, isobutyl 2-cyanoacrylate, 3-methoxybutyl cyanoacrylate, n-decyl cyanoacrylate, hexyl 2-cyanoacrylate, 2-ethoxyethyl 2-cyanoacrylate, 2-methoxyethyl 2-cyanoacrylate, 2-octyl 2-cyanoacrylate, 2-propoxyethyl 2-cyanoacrylate, n-octyl 2-cyanoacrylate and isoamyl cyanoacrylate.

In the context of the invention, use is preferably made of the monomers b). According to a preferred embodiment, the cyanoacrylate monomer(s) is (are) chosen from C₆-C₁₀ alkyl cyanoacrylates.

The monomers that are particularly preferred are the octyl cyanoacrylates of formula F and mixtures thereof: 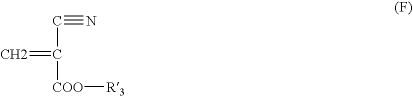
in which:
R′₃=—(CH₂)₇—CH₃,
   —CH(CH₃)—(CH₂)₅—CH₃,
   —CH₂—CH(C₂H₅)—(CH₂)₃—CH₃,
   —(CH₂)₅—CH(CH₃)—CH₃,
   —(CH₂)₄—CH(C₂H₅)—CH₃.

The monomers used in accordance with the invention may be covalently attached to supports such as polymers, oligomers or dendrimers. The polymer or the oligomer may be linear, branched, as a comb or as a block. The distribution of the monomers of the invention on the polymeric, oligomeric or dendritic structure may be random, at the end position or in the form of blocks.

In the composition of the invention, the amount of cyanoacrylate monomers is between 0.1 and 80% by weight of the total weight of the composition, preferably between 1 and 50%.

In the context of the invention, the electrophilic monomers are monomers capable of polymerizing via the anionic pathway in the presence of a nucleophilic agent. The term “anionic polymerization” is intended to mean the mechanism defined in the work “Advanced Organic Chemistry”, Third Edition by Jerry March, pages 151 to 161.

The nucleophilic agents capable of initiating anionic polymerization are systems known in themselves, capable of generating a carbanion on contact with a nucleophilic agent, such as the hydroxide ions contained in water at neutral pH. The term “carbanion” is intended to mean the chemical species defined in “Advanced Organic Chemistry”, Third Edition, by Jerry March, page 141.

The nucleophilic agents can be independently of the composition of the invention. The nucleophilic agent can also be added to the composition of the invention at the time of use.

The nucleophilic agent is a molecular compound, an oligomer, a dendrimer or a polymer having nucleophilic functions. Without implied limitation, nucleophilic functions that may be mentioned include the functions: R₂N⁻, NH₂⁻, Ph₃C⁻, R₃C⁻, PhNH⁻, pyridine, ArS⁻, R—C⁻C⁻, RS⁻, SH⁻, RO⁻, R₂NH, ArO⁻, N₃⁻, OH⁻, ArNH₂, NH₃, I⁻, Br⁻, Cl⁻, RCOO⁻, SCN⁻, ROH, RSH, NCO⁻, CN⁻, NO₃⁻, ClO₄⁻ and H₂O, Ph representing a phenyl group; Ar representing an aryl group and R representing a C₁-C₁₀ alkyl group.

The electrophilic monomers according to the present invention can be synthesized according to the known methods described in the art. In particular, the cyanoacrylate monomers can be synthesized according to the teaching of U.S. Pat. No. 3,527,224, U.S. Pat. No. 3,591,767, U.S. Pat. No. 3,667,472, U.S. Pat. No. 3,995,641, U.S. Pat. No. 4,035,334 and U.S. Pat. No. 4,650,826.

The appropriate dyeing medium used in the composition of the invention is preferably an anhydrous and non-hygroscopic medium. The term “anhydrous medium” is intended to mean a medium containing less than 1% of water.

According to this embodiment, the dyeing medium of the composition of the invention is preferably chosen from:
aromatic alcohols such as benzyl alcohol;
fatty alcohols;
modified or unmodified polyols, such as glycerol, glycol, propylene glycol, dipropylene glycol, butylene glycol or butyl diglycol;
volatile or non-volatile silicones, such as cyclopentasiloxane, cyclohexasiloxane, polydimethyl-siloxanes that are unmodified or modified with phenyl and/or siloxy and/or silanol and/or amine and/or imine and/or fluoroalkyl and/or carboxylic and/or betaine and/or quaternary ammonium, etc., functions;
mineral, organic or plant oils;
oxyethylenated or non-ethoxyethylenated waxes, paraffins, alkanes, and more particularly C₅ to C₁₀ alkanes;
fatty acids, fatty amides, fatty esters, and more particularly fatty alcohol benzoates or salicylates.

According to a preferred embodiment, the medium consists of a silicone such as polydimethyl-siloxanes and modified polydimethylsiloxanes.

Preferably, the organic compounds are chosen from compounds that are liquid at a temperature of 25° C. and under 105 Pa (760 mmHg).

The dyeing medium of the composition of the invention may also be in the form of an emulsion and/or may be encapsulated, the electrophilic monomers being maintained in an anhydrous medium until the moment of use. When the dyeing medium is an emulsion, this emulsion consists, for example, of a dispersed or continuous phase that may consist of water, C₁-C₄ aliphatic alcohols or mixtures thereof, and an anhydrous organic phase comprising the monomer. In the case of capsules or microcapsules, the capsule may contain the monomer in an anhydrous medium and may be dispersed in an anhydrous medium as defined above, water, C₁-C₄ aliphatic alcohols, or mixtures thereof.

Polymerization inhibitors, and more particularly anionic and/or radical polymerization inhibitors, may also be introduced into the composition of the invention in order to increase the stability of the composition over time. Without implied limitation, mention may be made of the following polymerization inhibitors: sulphur dioxide, nitric oxide, organic acids such as a sulphonic acid or phosphoric acid, acetic acid, lactone, boron trifluoride, hydroquinone and its derivatives, such as hydroquinone monoethyl ether or tert-butyl hydroquinone, benzoquinone and its derivatives, such as duroquinone, catechol and its derivatives, such as t-butyl catechol and methoxy-catechol, anisole and its derivatives, such as methoxy-anisole or hydroxyanisole, pyrogallol and its derivatives, p-methoxyphenol, hydroxybutyltoluene, alkyl sulphates, alkyl sulphites, alkyl sulphones, alkyl sulphoxides, alkyl sulphides, mercaptans, and mixtures thereof. The alkyl groups preferably denote groups having 1 to 6 carbon atoms.

The concentration of inhibitor in the composition of the invention may be between 10 ppm and 10%, and more preferably between 50 ppm and 5% by weight.

The composition of the invention may also contain one or more polymers that do not exhibit any reactivity on the electrophilic monomers and are capable of increasing the viscosity of the composition. The increase in viscosity makes it possible to reduce the rate of polymerization of the electrophilic monomers. To do this, it is possible to add to the composition of the invention, and in a nonexhaustive manner, poly(methyl methacrylate) (PMMA) or else the copolymers based on cyanoacrylate as described in U.S. Pat. No. 6 224 622.

The composition of the invention may also contain fillers. This comprises, without implied limitation, lamellar or non-lamellar, mineral or synthetic, colourless or white particles. They may be present in a proportion of 0 to 48% by weight, relative to the total weight of the composition, preferably 0.01 to 30% by weight, and better still from 0.02% to 20% by weight. Mention may in particular be made of talc, zinc stearate, mica, kaolin, polyamide powders (Nylon@) (Orgasol from Atochem), polyethylene powders, tetra-fluoroethylene polymer powders (TeflonB), starch, boron nitride, polymeric microspheres such as those made of polyvinylidene chloride/acrylonitrile, for instance Expancel (Nobel Industrie), or made of acrylic acid copolymers (PolytrapB from the company Dow Corning), and microbeads of silicone resin (TospearlsO from Toshiba, for example), elastomeric organopolysiloxanes.

The composition of the invention may also contain one or more conventional pigments. It may also contain metal powders or particles, such as aluminium, zinc, copper, etc., powders or particles.

The composition may also contain the cosmetic active agents normally used. Mention may be made, without implied limitation, of reducing agents, oxidizing agents, fatty substances, silicones, thickeners, softening agents, anti-foaming agents, moisturizers, emollients, basifying agents, elastomers, plasticizers, sunscreens, direct or oxidation dyes, clays, colloidal minerals, fragrances, peptizers, preserving agents, anionic, cationic, amphoteric, zwitterionic or non-ionic surfactants, fixing or non-fixing polymers, conditioning polymers, proteins, vitamins, etc.

These compositions may be in various forms, such as lotions, sprays or mousses, and may be applied in the form of a shampoo or of a conditioner.

In the case of sprays, the composition of the invention may contain a propellant. The propellant consists of the compressed or liquefied gases usually employed for the preparation of aerosol compositions. Use will preferably be made of air, carbon dioxide, compressed nitrogen, or else a soluble gas such as dimethyl ether, non-halogenated hydrocarbons or halogenated (in particular fluorinated) hydrocarbons, and mixtures thereof.

According to the process of the invention, the composition of the invention is applied to the keratin materials, in particular keratin fibres such as the hair, in the presence of a nucleophilic agent.

According to a particular embodiment of the process of the invention, the nucleophilic agent capable of initiating the polymerization of the electrophilic monomer can be applied beforehand to the keratin fibres. The nucleophilic agent may be used pure, in solution, or in the form of an emulsion, or may be encapsulated. It may also be added to the anhydrous composition at the time of use, just before application to the keratin fibres.

Preferably, this nucleophilic agent is water. This water may be provided, for example, by prior moistening of the keratin fibres. It may also be added directly to the composition before application.

According to a particular embodiment, it is possible to modulate the polymerization kinetics by moistening the fibre beforehand with an aqueous solution, the pH of which has been adjusted using a base, an acid or an acid/base mixture. The acid and/or the base may be inorganic or organic.

According to a variant, the process of the invention may be carried out in several steps: a first step which consists in applying a composition containing the pigment(s) to the fibres, and a second step which consists in applying a composition containing the electrophilic monomer, the nucleophilic agent being present in the composition containing the pigment or in a separate composition.

According to this variant, the composition containing the pigment(s) is preferably an aqueous solution of pigments, which makes it possible to moisten the fibre and to initiate the polymerization when the electrophilic monomer is applied.

According to the process of the invention, a preferred embodiment consists in applying either the electrophilic monomer and the pigments using the same composition, or in applying firstly the pigment, and then the electrophilic monomer.

The process of the invention may comprise additional intermediate or final steps, such as the application of a cosmetic product, a rinsing step or a drying step. The drying can be carried out with a hood, with a hairdryer and/or with straightening tongs. In particular, the application of the compositions in accordance with the invention may be followed by rinsing.

It is also possible to perform multiple applications of the composition of the invention in order to obtain a superposition of layers so as to attain specific properties of the deposit in terms of chemical nature, mechanical strength, thickness, appearance, feel.

In order to improve, inter alia, the adhesion of the polymer formed in situ, the fibre may be pretreated with polymers of all types.

In order to modulate the anionic polymerization kinetics, the nucleophilicity of the fibre can also be increased by chemical conversion of the keratin fibres. By way of example, mention may be made of reduction of the disulphide bridges, that partly make up keratin, to thiols before application of the composition of the invention. In a nonexhaustive manner, mention may be made, as agents that reduce the disulphide bridges partly making up keratin, of the following compounds: anhydrous sodium thiosulphate, powdered sodium metabisulphite, thiourea, ammonium sulphite, thioglycolic acid, thiolactic acid, ammonium thiolactate, glyceryl monothioglycolate, ammonium thioglycolate, thioglycerol, 2,5-dihydroxybenzoic acid, diammonium dithioglycolate, strontium thioglycolate, calcium thioglycolate, zinc formosulphoxylate, isooctyl thioglycolate, dl-cysteine, monoethanolamine thioglycolate.

The application of the composition of the invention may also be preceded by a hair treatment such as direct or oxidation dyeing.

According to the present invention, the monomers are preferably chosen from monomers capable of polymerizing on keratin fibres under cosmetically acceptable conditions. In particular, the poly-merization of the monomer is preferably carried out at a temperature of less than or equal to 80° C., preferably of between 10 and 80° C., preferably 20 to 80° C., which does not prevent the application from being finished with drying under a hood, blow-drying, or the use of a flat heating iron or curling tongs.

A subject of the invention is also a dyeing kit comprising a first composition which contains a pigment and a second composition which contains the electrophilic monomer(s) and, optionally, a third composition which contains the nucleophilic agent. According to this embodiment, the composition containing the pigment(s) is an aqueous composition and the composition containing the monomer(s) is an anhydrous composition.

According to a first variant, the kit comprises a first anhydrous composition which comprises the pigment(s) and the cyanoacrylate monomer(s), and a second composition which comprises a nucleophilic agent.

The following nonlimiting examples make it possible to illustrate the invention without limiting the scope thereof.

### EXAMPLES

Trials were carried out using the following compounds:

Monomer: 2-octyl 2-cyanoacrylate stabilized with 1% of phosphoric acid, known as RITE LOK CON895, sold by the company Chemence.

Pigment 1: Calcium salt of lithol red B, CI 15850, D & C Red 7 sold by the company Wackherr

Pigment 2: Phthalocyanin green, Pigment Green 7, CI 74260, sold by Clariant under the name Hostaperm Green GG 01.

Dyeing Medium:

50% of alpha,omega-dihydroxy polydimethyl-siloxane/cyclopentadimethylsiloxane mixture (14.7/85.3) sold by Dow Corning under the name DC 1501 Fluid,

50% of cyclopentadimethylsiloxane sold by Dow Corning under the name DC 245 Fluid.

### Example 1

An aqueous composition is prepared with 10% by weight of pigment 1. 0.5 g of this aqueous composition is applied to a lock of 1 g of clean and dry natural white hair.

The lock is subsequently dried under a hood.

The lock is moistened with 0.5 g of water. 0.5 g of a composition containing 10% by weight of cyanoacrylate monomer in the dyeing medium described above is subsequently applied to the lock.

After an application time of 15 minutes, the lock is dried for 2 minutes with a hairdryer.

The lock obtained is coloured red and the colour obtained persists after at least six shampooing operations.

### Example 2

A composition containing 10% of pigment 2 in the dyeing medium described above is prepared. The cyanoacrylate monomer is added to this composition so as to obtain a final concentration of 10% by weight of monomers. 0.5 g of this composition is applied to a lock of clean and dry natural hair with a tone strength equal to 4, moistened with 0.5 g of water.

After an application time of 15 minutes, the lock is dried for 2 minutes with a hairdryer.

The lock obtained is strongly coloured green and the colour obtained persists after at least six shampooing operations.

### Example 3

### Red Lake

The following composition is prepared:

| | |
|---|---|
| DC 1501 Fluid | 40 g |
| DC 245 Fluid | 39.2 g |
| Calcium salt of lithol red B, CI 15850, | 10 g |
| D&C Red 7 sold by the company Wackherr | |
| Polyhydroxystearic acid dispersant sold | 0.8 g |
| under the name Octacare DSP OL 300 by Avecia | |
| Methylheptyl cyanoacrylate from Chemence | 10 g |

0.5 g of the composition is applied to a lock of 1 g of clean and moist hair. After a period of 15 minutes, the lock is dried with a hairdryer for 2 minutes.

The lock is coloured and the coloration obtained is shampoo-fast.

### Example 4

### 2. Red Lake+Acetic Acid

The following composition A is prepared:

| | |
|---|---|
| Methylheptyl cyanoacrylate from Chemence | 97.5 g |
| Glacial acetic acid | 2.5 g |

The following composition B is prepared:

| | |
|---|---|
| DC 1501 Fluid | 40 g |
| DC 245 Fluid | 39.2 g |
| Calcium salt of lithol red B, CI 15850, | 10 g |
| D&C Red 7 sold by the company Wackherr | |
| Polyhydroxystearic acid dispersant sold | 0.8 g |
| under the name Octacare DSP OL 300 by Avecia | |
| Composition A | 10 g |

0.5 g of composition C is applied to a lock of 1 g of clean and moist hair. After a period of 15 minutes, the lock is dried with a hairdryer for 2 minutes.

The lock is coloured and the coloration obtained is shampoo-fast.

### Example 5

### Phthalocyanin

The following composition is prepared:

| | |
|---|---|
| DC 1501 Fluid | 40 g |
| DC 245 Fluid | 39.2 g |
| Phthalocyanin green, Pigment Green 7, | 10 g |
| CI 74260, sold by Clariant under the name | |
| Hostaperm Green GG 01 | |
| Polyhydroxystearic acid dispersant sold under | 0.8 g |
| the name Octacare DSP OL 300 by Avecia | |
| Methylheptyl cyanoacrylate from Chemence | 10 g |

0.5 g of the composition is applied to a lock of 1 g of clean and moist hair. After a period of 15 minutes, the lock is dried with a hairdryer for 2 minutes.

The lock is coloured and the coloration obtained is shampoo-fast.

### Example 6

### Pearlescent Agent Containing an Organic Pigment

The following composition is prepared:

| | |
|---|---|
| DC 1501 Fluid | 40 g |
| DC 245 Fluid | 40 g |
| Pearlescent agent mica coated with titanium | 10 g |
| oxide, coated with calcium lithol red B lake | |
| sold by Engelhard under the name Cellini Red | |
| Methylheptyl cyanoacrylate from Chemence | 10 g |

0.5 g of the composition is applied to a lock of 1 g of clean and moist hair. After a period of 15 minutes, the lock is dried with a hairdryer for 2 minutes.

The lock is coloured and the coloration obtained is shampoo-fast.

### Example 7

### Composite Pigment

The following composition is prepared:

| | |
|---|---|
| DC 1501 Fluid | 40 g |
| DC 245 Fluid | 39.2 g |
| Hybrid composite pigment quinacridone red | 10 g |
| on silica sold by Toda Kogyo under the name | |
| CS-R100Y | |
| Polyhydroxystearic acid dispersant sold under | 0.8 g |
| the name Octacare DSP OL 300 by Avecia | |
| Methylheptyl cyanoacrylate from Chemence | 10 g |

0.5 g of the composition is applied to a lock of 1 g of clean and moist hair. After a period of 15 minutes, the lock is dried with a hairdryer for 2 minutes.

The lock is coloured and the coloration obtained is shampoo-fast.

### Example 8

### Melanin

The following composition is prepared:

| | |
|---|---|
| DC 1501 Fluid | 40 g |
| DC 245 Fluid | 40 g |
| Melanin sold by Sigma under the reference M2649 | 10 g |
| Methylheptyl cyanoacrylate from Chemence | 10 g |

0.5 g of the composition is applied to a lock of 1 g of clean and moist hair. After a period of 15 minutes, the lock is dried with a hairdryer for 2 minutes.

The lock is coloured and the coloration obtained is shampoo-fast.

### Example 9

### Phthalocyanin and Ethoxyethyl Cyanoacrylate Monomer

The following composition K is prepared:

| | |
|---|---|
| DC 1501 Fluid | 40 g |
| DC 245 Fluid | 34.2 g |
| Phthalocyanin green, Pigment Green 7, CI 74260, | 10 g |
| sold by Clariant under the name | |
| Hostaperm Green GG 01 | |
| Polyhydroxystearic acid dispersant sold under | 0.8 g |
| the name Octacare DSP OL 300 by Avecia | |
| Glacial acetic acid | 5 g |
| Ethoxyethyl cyanoacrylate EO 460 from Tong Shen | 10 g |

0.5 g of the composition is applied to a lock of 1 g of clean and moist hair. After a period of 15 minutes, the lock is dried with a hairdryer for 2 minutes.

The lock is coloured and the coloration obtained is shampoo-fast.

### Example 10

### Phthalocyanin and Butyl Cyanoacrylate Monomer

The following composition C is prepared:

| | |
|---|---|
| Butyl cyanoacrylate B 60 from Tong Shen | 90 g |
| Glacial acetic acid | 10 g |

The following composition D is prepared:

| | |
|---|---|
| DC 1501 Fluid | 40 g |
| DC 245 Fluid | 39.2 g |
| Phthalocyanin green, Pigment Green 7, CI 74260, | 10 g |
| sold by Clariant under the name | |
| Hostaperm Green GG 01 | |
| Polyhydroxystearic acid dispersant sold under | 0.8 g |
| the name Octacare DSP OL 300 by Avecia | |
| Composition C | 10 g |

1.5 g of the composition D is applied to a lock of 1 g of clean and moist hair. After a period of 15 minutes, the lock is dried with a hairdryer for 2 minutes.

The lock is coloured and the coloration obtained is shampoo-fast.

### Example 11

### Phthalocyanin and Ethylhexyl Cyanoacrylate Monomer

The following composition is prepared:

| | |
|---|---|
| DC 1501 Fluid | 40 g |
| DC 245 Fluid | 39.2 g |
| Phthalocyanin green, Pigment Green 7, CI 74260, | 10 g |
| sold by Clariant under the name | |
| Hostaperm Green GG 01 | |
| Polyhydroxystearic acid dispersant sold under | 0.8 g |
| the name Octacare DSP OL 300 by Avecia | |
| Ethylhexyl cyanoacrylate O-60 from Tong Shen | 10 g |

1.5 g of the composition is applied to a lock of 1 g of clean and moist hair. After a period of 15 minutes, the lock is dried with a hairdryer for 2 minutes.

The lock is coloured and the coloration obtained is shampoo-fast.

### Example 12

### Phthalocyanin and Mixture of Methylheptyl Cyanoacrylate Monomer and Ethylhexyl Cyanoacrylate Monomer

The following composition is prepared:

| | |
|---|---|
| DC 1501 Fluid | 40 g |
| DC 245 Fluid | 39.2 g |
| Phthalocyanin green, Pigment Green 7, CI 74260, | 10 g |
| sold by Clariant under the name | |
| Hostaperm Green GG 01 | |
| Polyhydroxystearic acid dispersant sold under | 0.8 g |
| the name Octacare DSP OL 300 by Avecia | |
| Methylheptyl cyanoacrylate from Chemence | 9 g |
| Ethylhexyl cyanoacrylate from Tong Shen | 1 g |

1.5 g of the composition is applied to a lock of 1 g of clean and moist hair. After a period of 15 minutes, the lock is dried with a hairdryer for 2 minutes.

The lock is coloured and the coloration obtained is shampoo-fast.

### Example 13

### Phthalocyanin and Mixture of Methylheptyl Cyanoacrylate Monomer and Butyl Cyanoacrylate Monomer

The following composition is prepared:

| | |
|---|---|
| DC 1501 Fluid | 40 g |
| DC 245 Fluid | 39.2 g |
| Phthalocyanin green, Pigment Green 7, CI 74260, | 10 g |
| sold by Clariant under the name | |
| Hostaperm Green GG 01 | |
| Polyhydroxystearic acid dispersant sold under | 0.8 g |
| the name Octacare DSP OL 300 by Avecia | |
| Methylheptyl cyanoacrylate from Chemence | 7 g |
| Butyl cyanoacrylate B60 from Tong Shen | 3 g |

1.5 g of the composition is applied to a lock of 1 g of clean and moist hair. After a period of 15 minutes, the lock is dried with a hairdryer for 2 minutes.

The lock is coloured and the coloration obtained is shampoo-fast.

### Example 14

### Carbon Black

The following composition is prepared:

| | |
|---|---|
| DC 1501 Fluid | 40 g |
| DC 245 Fluid | 39.2 g |
| Carbon black, Unipure Black LC902 sold by LCW | 10 g |
| Polyhydroxystearic acid dispersant sold under | 0.8 g |
| the name Octacare DSP OL 300 by Avecia | |
| Methylheptyl cyanoacrylate from Chemence | 10 g |

0.5 g of the composition is applied to a lock of 1 g of clean and moist hair. After a period of 15 minutes, the lock is dried with a hairdryer for 2 minutes.

The lock is coloured and the coloration obtained is shampoo-fast.

1. Dyeing composition comprising, in an appropriate dyeing medium, at least one pigment comprising at least one organic part and at least one electrophilic monomer.

2-32. (canceled)
